(19) United States
(12) Patent Application Publication
(10) Pub. No.: US 2023/0408821 A1
(43) Pub. Date: Dec. 21, 2023

(54) NEAR-EYE DISPLAY DEVICE AND WEARABLE DEVICE HAVING THE SAME

(71) Applicant: LINGXI-AR Technology Co., Ltd., Beijing (CN)

(72) Inventors: Zhiyuan GU, Beijing (CN); Xin ZHAO, Beijing (CN); Yu ZHENG, Beijing (CN)

(21) Appl. No.: 18/212,354

(22) Filed: Jun. 21, 2023

(30) Foreign Application Priority Data
Jun. 21, 2022 (CN) 202210703506.3

(51) Int. Cl. G02B 27/01; G03H 1/00; G03H 1/02; G03H 1/04

(52) U.S. Cl. CPC G02B 27/0172; G03H 1/0005; G03H 1/0272; G03H 1/0443; G02B 2027/0174; G02B 2027/0123; G03H 2222/34; G03H 2222/42

(57) ABSTRACT

A near-eye display device and a wearable device having the same. The near-eye display device includes a laser generation module, an optical waveguide element, and a holographic optical element; the laser generation module is configured to emit parallel laser beams; the optical waveguide element has an in-coupler area and an out-coupler area, the optical waveguide element is configured to receive the parallel laser beams and output the parallel laser beams in parallel after one-dimensional pupil expansion or two-dimensional pupil expansion; the holographic optical element has interference fringes and is attached to the out-coupler area, the holographic optical element is configured to receive the parallel laser beams from the optical waveguide element and to reflect or transmit the parallel laser beams by diffraction to output a plurality of converging image light beams.

### CROSS-REFERENCE TO RELATED APPLICATIONS

The present application claims the benefit of Chinese patent application No. 202210703506.3 filed on Jun. 21, 2022, titled “NEAR-EYE DISPLAY DEVICE AND WEARABLE DEVICE HAVING THE SAME”, the entire contents of which are incorporated herein by reference.

### TECHNICAL FIELD

The present application relates to the technical field of optical technology, and particularly to a near-eye display device and a wearable device having the same.

### BACKGROUND

Optical waveguides are considered to be an essential optical solution for near-eye displays in consumer augmented reality (AR) wearable devices due to their thinness and high penetration of external light, which can achieve a good form of product and superior display effects. Optical waveguides can be divided into diffraction waveguides (DWGs) and reflective waveguides (RWGs) according to the form of coupling optics. Diffraction waveguides achieve exit pupil expander of the incident light by means of a grating structure etched on the waveguide surface, while reflective waveguides realize exit pupil expander of the incident light by means of a partial mirror array according to the principle of geometric optics.

However, the current optical waveguide mainly relies on total reflection for light transmission, in general, in order to avoid ghost images and ghosting problems, the light transmitted in the optical waveguide is generally parallel light in multiple directions, and, when a larger field of view is to be achieved, the angle of divergence between a series of parallel light will become larger, which will face problems such as smaller eye box and increased waveguide volume; at the same time, because the optical waveguide mainly plays the role of transmission and pupil dilation At the same time, because the light waveguide mainly plays the role of transmission and pupil dilation, so that the light from the waveguide is also parallel light, so the image observed by the human eye is a fixed position of the image, long time wearing will cause visual convergence, causing discomfort.

Therefore, it is desirable to develop a near-eye display device and a wearable device with a large eye box, small size, and infinite depth of field.

### SUMMARY

An objective of the present application is to provide a near-eye display device and a wearable device having the same, aiming to obtain a near-eye display device and wearable device with a large eye box, small size and infinite depth of field.

In a first aspect, the present application provides a near-eye display device including a laser generation module, an optical waveguide element, and a holographic optical element; the laser generation module is configured to emit parallel laser beams; the optical waveguide element has an in-coupler area and an out-coupler area, the optical waveguide element is configured to receive the parallel laser beams and output the parallel laser beams in parallel after one-dimensional pupil expansion or two-dimensional pupil expansion; the holographic optical element has interference fringes and is attached to the out-coupler area, the holographic optical element is configured to receive the parallel laser beams from the optical waveguide element and to reflect or transmit the parallel laser beams by diffraction to output a plurality of converging image light beams.

In an optional embodiment, the optical waveguide element includes an in-coupler module, a turning module, and an out-coupler module sequentially arranged along a light transmission direction, the in-coupler module is configured to couple the parallel laser beams into the turning module, the turning module is configured to change a propagation direction of the parallel laser beams and to achieve pupil expansion of the parallel laser beams in a first direction; the out-coupler module is configured to achieve pupil expansion of the parallel laser beams in a second direction after the pupil expansion in the first direction and to output the laser beams, the second direction is set at an angle to the first direction.

In an optional embodiment, the turning module includes a first waveguide substrate and a first beam-splitting structure formed within the first waveguide substrate, the first beam-splitting structure includes a plurality of first beam-splitting films spaced along the first direction; the out-coupler module includes a second waveguide substrate and a second beam-splitting structure formed within the second waveguide substrate, the second beam-splitting structure includes a plurality of second beam-splitting films spaced along the second direction.

In an optional embodiment, the holographic optical element includes a plurality of holographic lenses disposed sequentially in the second direction, the holographic lenses are reflective holographic lenses or transmissive holographic lenses, the plurality of holographic lenses are disposed in correspondence with the plurality of second beam-splitting films, each of the holographic lenses has the interference fringes formed thereon for receiving light beam reflected from a corresponding second beam-splitting film and outputting the image light beams.

In an optional embodiment, the holographic lenses are recorded by a holographic lens recording system, when the holographic lenses are reflective holographic lenses, the holographic lens recording system includes a first lens, a second lens, a glass substrate, a holographic film, and a third lens, the holographic film is attached to the glass substrate; a signal light is collimated by the first lens and is focused on the holographic film through the second lens and the glass substrate; a reference light passes through the third lens to obtain a parallel reference light, the parallel light is incident on the holographic film and coherent with the signal light to form the interference fringes.

In an optional embodiment, the turning module is located at one end in a lengthwise direction of the out-coupler module, or above the out-coupler module;

when the turning module is located at the one end in the lengthwise direction of the out-coupler module, the in-coupler module is located on a side of the turning module away from the out-coupler module.

In an optional embodiment, when the turning module is located at the one end in the lengthwise direction of the out-coupler module, a tapered portion is provided on a side of the first waveguide substrate away from the out-coupler module, the tapered portion has an oblique surface as a light incident surface, the in-coupler module is a triangular prism, and a light emitting surface of the triangular prism is attached to the light incident surface of the tapered portion, so that the triangular prism and the tapered portion form a triangular structure.

In an optional embodiment, a degree of an apex angle of the triangular structure away from the out-coupler module is twice a tilt angle of the second beam-splitting films, and a tilt angle of the first beam-splitting films is 45°.

In an optional embodiment, the laser generation module includes a laser generation body and a collimation module, and the laser generation body includes a light source, a beam combiner, and a scanning module arranged in sequence along a light propagation path, the light source is an RGB three-color light source, and a light beam emitted by the light source is integrated by the beam combiner and then passes through the scanning module and the collimation module in sequence to form the parallel laser beams.

In a second aspect, provided is a wearable device including the near-eye display device provided in the above embodiments.

The advantageous effect of the present application compared with the existing technology is that the near-eye display device and wearable device provided by the embodiment of the present application includes a laser generation module, an optical waveguide element and a holographic optical element, the optical waveguide element is configured to receive a parallel laser beam from the laser generation module and can output the parallel laser beam after one-dimensional pupil expansion or two-dimensional pupil expansion; the holographic optical element has interference fringes and is attached to the out-coupler area, capable of receiving the parallel laser beam from the optical waveguide element and reflecting or transmitting the parallel laser beam through diffraction to output a plurality of converging image beams. In this case, the plurality of image beams are arranged at intervals. With this structure, both the one-dimensional pupil expansion or two-dimensional pupil expansion of the light beam is realized, the eye box of the near-eye display device is enlarged, and the volume is smaller, while the laser generation module and the holographic optical element can cooperate to achieve the effect of small-aperture imaging to realize infinite depth of field. In summary, the near-eye display device provided by the embodiment of the present application, with the laser generation module, body holography, and optical waveguide technology, can achieve a large eye box and infinite depth of field in a small volume.

### BRIEF DESCRIPTION OF THE DRAWINGS

In order to more clearly illustrate the technical solutions of the embodiments of the present application, the following will briefly introduce the accompanying drawings that need to be used in the embodiments of the present application or in the description of the prior art. Obviously, the accompanying drawings described below are only illustrations of the present application For some embodiments, those of ordinary skill in the art can also obtain other drawings based on these drawings without any creative effort.

FIG. 1 is a schematic diagram of a front view of the near-eye display structure provided by an embodiment of the present application;

FIG. 2 is a schematic diagram of a top view of the near-eye display structure shown in FIG. 1;

FIG. 3 is a schematic diagram of a side view of the near-eye display structure shown in FIG. 1;

FIG. 4 is a schematic diagram of the state of use of the holographic lens recording system adopted in an embodiment of the present application;

FIG. 5 is a schematic diagram of the optical path of the holographic optical element obtained through the holographic lens recording system shown in FIG. 4, in which the holographic optical element is a reflective holographic optical element;

FIG. 6 is a schematic diagram of a perspective structure of the optical waveguide element adopted in an embodiment of the present application;

FIG. 7 is a schematic diagram of a perspective structure of the optical waveguide element adopted in an embodiment of the present application;

FIG. 8 is a schematic diagram of a side view of the optical waveguide element shown in FIG. 7; and

FIG. 9 is a schematic diagram of the main view of the turning module and the in-coupler module in the optical waveguide element shown in FIG. 1;

Reference numbers in the drawings are as follows:

100, laser generation module; 110, laser generation body; 120, collimation module; 200, optical waveguide element; 210, in-coupler module; 220, turning module; 221, first waveguide substrate; 222, first beam-splitting film; 223, tapered section; 230, out-coupler module; 231, second waveguide substrate; 232, second beam-splitting film; 300, holographic optical element 310, holographic lens; 400, holographic lens recording system; 410, first lens; 420, second lens; 430, glass substrate; 440, holographic film; 450, third lens; X, first direction; Y, second direction; θ, degree of the apex angle of the triangular structure away from the out-coupler module; α, tilt angle of the second beamsplitter film; and β, tilt angle of the first beamsplitter film.

### DETAILED DESCRIPTION OF THE EMBODIMENTS

Embodiments of the present application are described in detail below, examples of which are shown in the drawings, the same or similar reference numerals designate the same or similar elements or elements having the same or similar functions throughout. The embodiments described below by referring to the drawings are exemplary and are intended to explain the present application and should not be construed as limiting the present application.

It is understood that the terms “length”, “width”, “upper”, “lower”, “front”, “rear”, “left”, “right”, “vertical”, “horizontal”, “top”, “bottom”, “inside”, “outside”, etc. indicating an orientation or positional relationship are based on the orientation or positional relationship shown in the accompanying drawings and are intended only to facilitate and simplify the description of the application, not to indicate or imply that the device or element referred to must have a particular orientation, be constructed and operate in a particular orientation, and therefore are not to be construed as limiting the application.

In addition, the terms “first” and “second” are used for descriptive purposes only and are not to be construed as indicating or implying relative importance or implicitly specifying the number of technical features indicated. Thus, the features qualified with “first” and “second” may explicitly or implicitly include one or more such features. In the description of the present application, “a plurality of” means two or more, unless otherwise expressly and specifically limited.

In the present application, unless otherwise clearly specified and limited, terms such as “install”, “connected”, “connection” and “fix” should be understood in a broad sense, for example, it can be a fixed connection or a detachable connection, or integrated; it can be mechanically connected or electrically connected; it can be directly connected or indirectly connected through an intermediary, and it can be the internal communication of two components or the interaction relationship between two components. Those of ordinary skill in the art can understand the specific meanings of the above terms in the present application according to specific situations.

In order to make the purpose, technical solutions and advantages of the present application more clearly understood, the following is a further detailed description of the present application in conjunction with the accompanying drawings and embodiments.

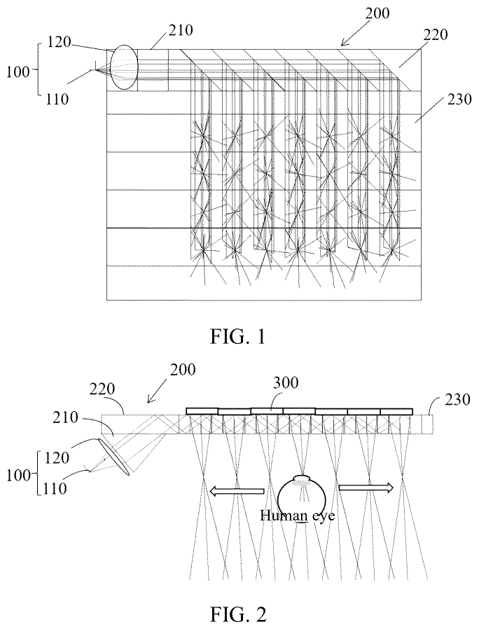

Referring to FIGS. 1 to 3, in an embodiment of the present application, provided is a near-eye display device including a laser generation module 100, an optical waveguide element 200, and a holographic optical element 300.

The laser generation module 100 is configured to emit parallel laser beams. The parallel laser beams are generally formed by the red, green, and blue laser beams through the scanning module and the collimation module 120, or can also adopt a monochrome laser beam, depending on the actual needs. Each beam in the parallel laser beams represents a pixel, and all the beams converge together to form a complete image.

The optical waveguide element 200 has an in-coupler area and an out-coupler area, and the optical waveguide element 200 is configured to receive the parallel laser beams and output the parallel laser beams after one-dimensional pupil expansion or two-dimensional pupil expansion. Specifically, the optical waveguide element 200 in this embodiment can be a reflective light waveguide or a diffractive light waveguide, which can be flexibly selected according to the actual needs, and is not limited herein.

The holographic optical element (HOE) 300 has interference fringes and is attached to the out-coupler area of the optical waveguide element 200. The holographic optical element 300 is configured to receive the parallel light beams output from the optical waveguide element 200 and to reflect or transmit the parallel laser beams by diffraction so as to output a plurality of converging image beams.

Specifically, the holographic optical element 300 in this embodiment may be a reflective holographic lens array or a transmissive holographic lens array. The holographic optical element 300 generally includes a substrate and a holographic film 440, and interference fringes are formed within the holographic film 440 by interference between a reference light and a signal light. More specifically, when the holographic optical element 300 uses a reflective holographic lens array, the reference light and signal light irradiate the holographic film 440 from both sides of the holographic film 440 to form the interference fringes; when the holographic optical element 300 uses a transmissive holographic lens array, the reference light and signal light irradiate the holographic film 440 from the same side of the holographic film 440 to form the interference fringes.

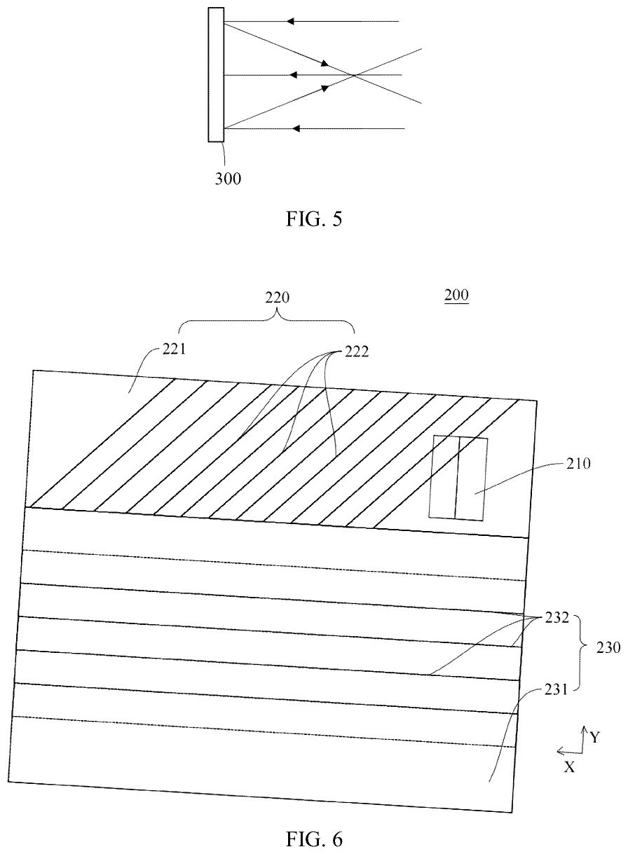

For ease of understanding, FIG. 4 shows the exposure mechanism of a single reflective holographic lens when the holographic optical element 300 adopts a reflective holographic lens array. The signal light is collimated to parallel light by a first collimating lens, and becomes a converging spherical wave incident on the HOE after passing through the focusing lens, while the reference light is collimated by a second collimating lens and incident on the HOE. After the HOE completes recording, when the parallel light (light similar to the above reference light) is incident on the HOE, the parallel light will be focused and reflected, forming a beam similar to the signal light, as shown in FIG. 5.

The workflow of the near-eye display device provided by embodiments of the present application is as follows:

When in use, the laser generation module 100 is activated to emit parallel laser beams, after which the parallel laser beams enter the optical waveguide element 200 through the in-coupler area of the optical waveguide element 200, and after a one-dimensional pupil expansion or two-dimensional pupil expansion by the optical waveguide element 200, the parallel laser beams are first emitted in parallel through the out-coupler area of the optical waveguide element 200 and enters the holographic optical element 300.

After that, if the holographic optical element 300 is a transmissive structure, the parallel laser beams irradiated to the holographic optical element 300 are diffracted by the interference fringes on the holographic optical element 300 and emitted through the other side of the holographic optical element 300 to form a converged image light; if the holographic optical element 300 is a reflective structure, the parallel laser beams irradiated to the holographic optical element 300 are diffracted by the interference fringes on the holographic optical element 300 and emitted through the holographic optical element 300 to form a converged image light and is emitted through the optical waveguide element 200.

At the same time, the ambient light in the real world can pass through the near-eye display device directly into the human eye, so that the human eye can see the image through the near-eye display device as a superimposed image of the virtual image and the display image to achieve the purpose of augmented reality.

In the above process, an irradiation angle of the parallel laser beams irradiated to the holographic optical element 300 is comparable to that of the reference light forming the interference fringes on the holographic optical element 300, and the image light generated by diffraction of the holographic optical element 300 corresponds to the signal light forming the interference fringes on the holographic optical element 300.

The near-eye display device provided by the embodiment of the present application includes a laser generation module 100, an optical waveguide element 200, and a holographic optical element 300, the optical waveguide element 200 is configured to receive the parallel laser beams from the laser generation module 100 and can output the parallel laser beams after the one-dimensional pupil expansion or two-dimensional pupil expansion. The holographic optical element 300 has interference fringes and is attached to the out-coupler area of the optical waveguide element 200, for receiving the parallel laser beams from the optical waveguide element 200, and reflecting or transmitting the parallel laser beams through diffraction so as to output a plurality of converging image beams. In this case, the plurality of image beams are arranged at intervals. Using this structure, both the one-dimensional pupil expansion and two-dimensional pupil expansion of the light beam can be realized, increasing the eye box of the near-eye display device, while reducing the volume thereof; the laser generation module 100 and the holographic optical elements 300 can cooperate to achieve the effect of small-aperture imaging to achieve an infinite depth of field. In summary, the near-eye display device provided by the embodiment of the present application, with the laser generation module 100, the body holography and the optical waveguide technology, can achieve a large eye box and infinite depth of field in a very small volume.

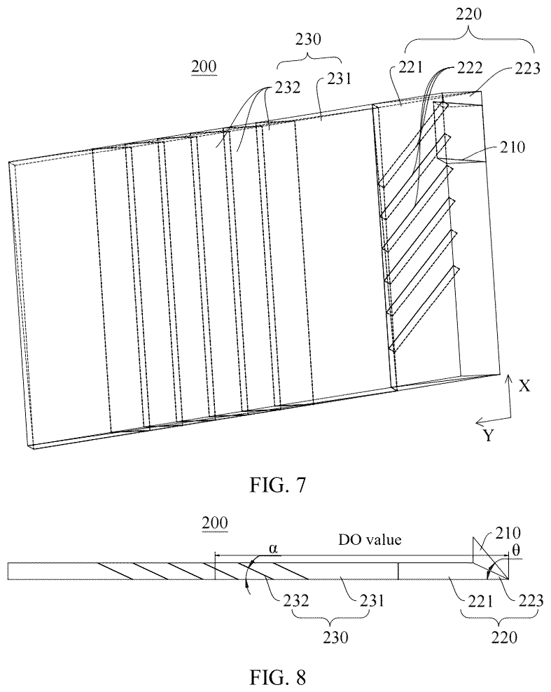

In an optional embodiment, as shown in FIG. 6 and FIG. 7, the optical waveguide element 200 includes an in-coupler module 210, a turning module 220, and an out-coupler module 230, which are disposed sequentially along the light transmission direction, the in-coupler module 210 is configured to couple the parallel laser beams into the turning module 220, the turning module 220 is configured to change the propagation direction of the parallel laser beams and realize the pupil expansion of the parallel laser beams in a first direction X. The out-coupler module 230 is configured to realize the pupil expansion of the parallel laser beams in a second direction Y, and output the laser beams. The second direction Y is set at an angle with the first direction X.

Specifically, the first direction X may be a lengthwise direction, a height direction, or other directions of the out-coupler module 230. The second direction Y can be set according to the direction of the first direction X. For example, when the first direction Xis the lengthwise direction of the out-coupler module 230, the second direction Y can be the height direction of the out-coupler module 230, or any direction set at an acute angle to the height direction of the out-coupler module 230; when the first direction X is the height direction of the out-coupler module 230, the second direction Y can be the lengthwise direction of the out-coupler module 230, or any direction set at an acute angle to the length direction of the out-coupler module 230. This can be flexibly selected according to the actual needs. The second direction Y can be set perpendicular to the first direction X or at other non-zero angles to achieve two-dimensional pupil expansion.

The in-coupler module 210 in this embodiment can use a reflective prism, so that the light entering the reflective prism can enter the turning module 220 after reflection; it can also use a reflector or other in-coupler structure, as long as the light passing through the in-coupler module 210 can enter the turning module 220. The turning module 220 may use prisms arranged sequentially along the first direction X, and each prism has a beam-splitting film attached to the output surface, so that a part of the light passing through the output surface of the prism can be reflected to exit through the side face of the prism, and another part pass through the beam-splitting film into the next prism, so as to achieve pupil expansion in the first direction X. The turning module 220 can also use a geometric light waveguide that can achieve pupil expansion in the first direction X. The out-coupler module 230 may use prisms sequentially arranged in the second direction Y, a beam-splitting film is attached on the output surface of each prism, so that a part of the light passing through the output surface of the prism can be partly reflected and exit from the side of the prism, another part can pass through the beam-splitting film into the next prism, so as to achieve pupil expansion in the second direction Y. The out-coupler module 230 can also use geometric light waveguide that can achieve pupil expansion in the second direction Y.

The optical waveguide element 200 adopting the structure provided in this embodiment has a simple structure and good pupil expansion effect.

In an optional embodiment, as shown in FIG. 6, the turning module 220 is located above the out-coupler module 230, while the display center of the out-coupler module 230 is located toward the bottom.

In another optional embodiment, as shown in FIGS. 7 and 8, the turning module 220 is located at one end in the lengthwise direction of the out-coupler module 230, and the in-coupler module 210 is located on a side of the turning module 220 away from the out-coupler module 230. In the light waveguide element 200 provided in this embodiment, the position of the in-coupler module 210 and the turning module 220 is no longer located above the out-coupler module 230, but at one end in the lengthwise direction of the out-coupler module 230, so that when applied to the near-eye display device or smart glasses, the position of the display center of the light waveguide element 200 and the horizontal distance from the display center of the light waveguide element 200 to the mirror legs (i.e., DO value) are changed. For example, when the light waveguide element 200 provided in this embodiment is used in smart glasses, the image source can be arranged on the glasses leg, the in-coupler module 210 and the turning module 220 can be arranged close to the glasses leg, and the out-coupler module 230 is located at the lens, so that the display center of the out-coupler module 230 can correspond to the position of the center of an ordinary lens and will not be located downward, and at the same time, because the in-coupler module 210 and the turning module 220 are arranged close to the glasses leg, the horizontal distance (i.e. DO value) from the display center of the light waveguide element 200 to the glass leg can be increased, which is more in line with the general wearing habits of users and helps to improve the user experience.

In an exemplary embodiment, as shown in FIG. 6 and FIG. 7, the turning module 220 includes a first waveguide substrate 221 and a first beam-splitting structure formed within the first waveguide substrate 221, the first beam-splitting structure includes a plurality of first beam-splitting films 222 spaced along the first direction X. The out-coupler module 230 includes a second waveguide substrate 231 and a second beam-splitting structure formed within the second waveguide substrate 231, the second beam-splitting structure includes a plurality of second beam-splitting films 232 spaced along the second direction Y.

In this embodiment, the first beam-splitting films 222 and the second beam-splitting films 232 are arranged at an angle, i.e., the first beam-splitting films 222 are arranged at an acute angle to the first direction X, and the second beam-splitting films 232 are arranged at an acute angle to the second direction Y. In this way, the light reflected by each beam-splitting film can be emitted through the side wall of the corresponding waveguide substrate. In addition, both the first beam-splitting films 222 and the second beam-splitting films 232 have a certain beam-splitting ratio, which can be the same or different, depending on the requirements for the light output effect. The turning module 220 and the out-coupler module 230 adopting the structure provided in this embodiment have a simple structure, and is easy to design and manufacture, with a good light output effect.

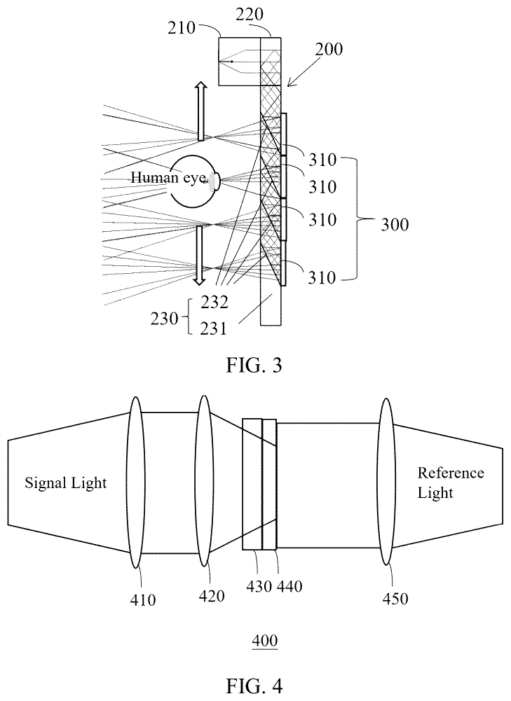

In an exemplary embodiment, as shown in FIG. 3, the holographic optical element 300 includes a plurality of holographic lenses 310 arranged sequentially along the second direction Y. The holographic lenses 310 are reflective holographic lenses or transmissive holographic lenses, and the plurality of holographic lenses 310 are provided in correspondence with the plurality of second beam-splitting films 232, and each holographic lens 310 is formed with interference fringes for receiving light reflected from the corresponding second beam-splitting film 232 and outputting an image light.

Since all light beams coupled into the turning module 220 via the in-coupler module 210 are at the same angle, the light path is fixed, so the position of the laser generation module 100 and the optical waveguide element 200 can be precisely controlled so that each holographic lens 310 in the holographic optical element 300 match each exit-pupil beam after pupil expansion, so that the light incident to each holographic lens 310 is at the same position, so that the convergent light reflected and focused through the holographic lens 310 is the same, so that the human eye can observe the convergent image light at multiple locations, that is, the image can be observed at multiple locations. At the same, because the light incident to the optical waveguide element 200 is parallel light at one angle, the turning module 220 can be made small enough to satisfy the transmission of the entire image.

The holographic optical element 300 in this embodiment can be obtained by direct exposure through the microlens array or by changing the position of a single lens for multiple exposures, which can be flexibly selected according to the actual needs. The holographic optical element 300 with the structure provided in this embodiment can receive all the light reflected from the second beam splitter 232 and form multiple image beams distributed at intervals to achieve a higher utilization of light. The holographic optical element 300 in this embodiment only converges the polarized light emitted through the optical waveguide element 200, and can completely transmit the unpolarized natural light.

In an optional embodiment, as shown in FIG. 4, the holographic lens is recorded by a holographic lens recording system 400, when the holographic lens is a reflective holographic lens, the holographic lens recording system 400 includes a first lens 410, a second lens 420, a glass substrate 430, a holographic film 440, and a third lens 450, the holographic film 440 is attached to the glass substrate 430. The signal light is collimated by the first lens 410 and then focused on the holographic film 440 through the second lens 420 and the glass substrate 430; the reference light passes through the third lens 450 to obtain parallel reference light, and the parallel light is incident on the holographic film 440 to form interference fringes coherent with the signal light.

Both the first lens 410 and the third lens 450 in this embodiment are collimating lenses, and the second lens 420 is a focusing lens, each lens can be composed of one or more lenses, and can be flexibly selected according to the actual needs. The holographic lens is recorded using the holographic lens recording system provided in this embodiment, so that the formed interference fringes are easy to control with a good light output effect.

In an optional embodiment, as shown in FIGS. 7 and 8, the first waveguide substrate 221 is provided with a tapered portion 223 protruded on the side of the first waveguide substrate 221 away from the out-coupler module 230. The tapered portion 223 has an oblique surface as a light incident surface. Specifically, the tapered portion 223 may be integrally formed with the body of the first waveguide substrate 221 or may be a separate component attached to a corresponding side wall of the body of the first waveguide substrate 221, depending on the design requirements.

The in-coupler module 210 is a triangular prism, and the output surface of the triangular prism is attached to the light incident surface of the tapered portion 223, and the two form a triangular structure.

Specifically, the triangular prism has a light incident surface and a light emitting surface, and the other surfaces may be reflective surfaces to ensure that the light entering the triangular prism through the light incident surface can all enter the turning module 220 through the triangular prism. At the same time, in addition to the light incident and light emitting surface, other surfaces in the turning module 220 may also be reflective surfaces, to ensure that the light entering the turning module 220 can all enter the out-coupler module 230.

The working mechanism of optical waveguide element 200 provided in this embodiment is as follows:

After entering the in-coupler module 210 through the light incident surface of the in-coupler module 210, the light can be transmitted by the in-coupler module 210 or reflected by the reflective surface, and be directed into the turning module 220 through the light emitting surface of the in-coupler module 210 and the light incident surface of the turning module 220, and then be completely reflected by the tapered portion 223 and the first waveguide substrate 221 to reach the area where the first beam-splitting film 222 is located, and then the light is emitted from the turning module 220 after being split and pupil-expanded by the first beam-splitting film 222 and enters the out-coupler module 230, which is then completely reflected by the second waveguide substrate 231 to the to reach the area where the second beam-splitting film 232 is located, finally is split and pupil-expanded by the second beam-splitting film 232 and emitted.

The coupling module 210 and the first waveguide substrate 221 use the structure provided in this embodiment, resulting in a smaller size of the two connected assemblies, which in turn results in a smaller size of the entire optical waveguide element 200.

In an optional embodiment, as shown in FIG. 8, the triangular structure formed by the in-coupler module 210 and the above-mentioned tapered portion 223 has an apex angle away from the out-coupler module 230 of 0 degree, where θ is two times the tilt angle α of the second beam-splitting film 232. With this arrangement, the central light emitted through the out-coupler module 230 can be emitted at an angle perpendicular to the plate surface of the second waveguide substrate 231, resulting in a good light emitting effect of the optical waveguide element 200.

In an optional embodiment, the second direction Y is perpendicular to the first direction X, in order to make the light waveguide element light area larger, so as to facilitate the user to observe the image in a larger area, improving the user experience.

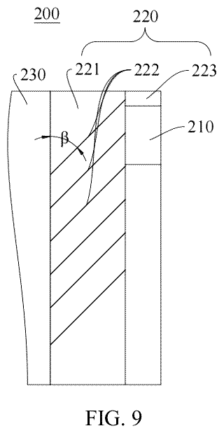

In an optional embodiment, the tilt angle β of the first beam-splitting film 222 is 45°, as shown in FIG. 9. This is configured to facilitate design and manufacturing while providing good pupil expansion effect.

The laser generation module in each of the above embodiments may have a variety of forms. In an exemplary embodiment, the laser generation module may include a laser generator, a scanning module, and a collimation module. One or more laser generator can be provided, and when more than one laser generators are provided, the light emitted from each laser generator can be the same or different in color, depending on the needs of use, and the light emitted from multiple laser beams forms an outgoing laser beam. The scanning module can be any one of a rotating mirror, a one-dimensional vibrating mirror, a two-dimensional vibrating mirror, a one-dimensional vibrating mirror+rotating mirror, etc., to receive the laser beam and realize the one-dimensional or two-dimensional scanning of the laser beam. The collimation module may include one or more lenses for receiving the scanning light beams and collimating them to output to the optical waveguide element.

In another exemplary embodiment, the laser generation module may include a plurality of laser generators arranged in an array, and a collimation module. The plurality of laser generators may be arranged in a one-dimensional array or a plurality of arrays to emit an array of laser beams, and the collimation module may include one or more lenses for receiving the laser beams and collimating them for output into an optical waveguide element.

Of course, in other embodiments, the laser generation module can also use other structures, as long as it can output a parallel laser beam that meets the design requirements, and is not limited here.

In an optional embodiment, as shown in FIGS. 1 and 2, the laser generation module 100 includes a laser generation body 110 and a collimation module 120. The laser generation body 110 includes a light source, a beam combiner, and a scanning module, which are disposed in sequence along the light propagation path. The light source is an RGB tricolor light source, and the beams from the light source are integrated by the beam combiner and then formed into parallel laser beams by the scanning module and the collimation module 120 in turn. Specifically, the light source in this embodiment can include three monochromatic light sources, namely a red light source, a green light source, and a blue light source, the three monochromatic light sources are disposed around the beam combiner. When used, the light beams from the three monochromatic light sources are combined through the beam combiner into a colored beam, and the beam first passes through the scanning module to form a scanning beam, and then is collimated through the collimation module 120 and output to form a parallel laser beam.

Due to the nature of laser beam scanning (LBS), each monochromatic light source can be regarded as a point light source, and each light beam after the combined beam represents a pixel, and all pixels can be converged to form a complete image. The laser generation module 100 adopting the structure provided in this example has a simple structure and a stable light output effect.

In an optional embodiment, the scanning module is a two-dimensional MEMS (micro-electro-mechanical system) scanning oscillator, which has the advantages of small size, light weight, low power consumption, good durability, low price, stable performance, etc. It is suitable for portable miniature near-eye display devices and has a broad market prospect.

In another embodiment of the present application, a wearable device is provided, which can be AR smart glasses, a smart headband, a smart mask, etc., which can be flexibly selected according to the actual needs. The wearable device provided in this embodiment includes the near-eye display device provided in each of the above embodiments, thus the size of the wearable device can be reduced, with an increasing eye box and an infinite depth of field.

The above descriptions are only preferred embodiments of the present application, and only specifically describe the technical principle of the present application. These descriptions are only for explaining the principle of the present application, and cannot be interpreted as limiting the protection scope of the present application in any way. Based on the explanations here, any modifications, equivalent replacements and improvements made within the spirit and principles of the present application, and those skilled in the art who can think of other specific implementations of the present application without creative work are all Should be included within the protection scope of the present application.

1. A near-eye display device comprising:
a laser generation module;
an optical waveguide element; and
a holographic optical element;
wherein
the laser generation module is configured to emit parallel laser beams;
the optical waveguide element has an in-coupler area and an out-coupler area, the optical waveguide element is configured to receive the parallel laser beams and output the parallel laser beams in parallel after one-dimensional pupil expansion or two-dimensional pupil expansion; and
the holographic optical element has interference fringes and is attached to the out-coupler area, the holographic optical element is configured to receive the parallel laser beams from the optical waveguide element and to reflect or transmit the parallel laser beams by diffraction to output a plurality of converging image light beams.

2. The near-eye display device according to claim 1, wherein the optical waveguide element comprises an in-coupler module, a turning module, and an out-coupler module sequentially arranged along a light transmission direction, the in-coupler module is configured to couple the parallel laser beams into the turning module, the turning module is configured to change a propagation direction of the parallel laser beams and to achieve pupil expansion of the parallel laser beams in a first direction; the out-coupler module is configured to achieve pupil expansion of the parallel laser beams in a second direction after the pupil expansion in the first direction and to output the laser beams, the second direction is set at an angle to the first direction.

3. The near-eye display device according to claim 2, wherein the turning module comprises a first waveguide substrate and a first beam-splitting structure formed within the first waveguide substrate, the first beam-splitting structure comprises a plurality of first beam-splitting films spaced along the first direction; the out-coupler module comprises a second waveguide substrate and a second beam-splitting structure formed within the second waveguide substrate, the second beam-splitting structure comprises a plurality of second beam-splitting films spaced along the second direction.

4. The near-eye display device according to claim 3, wherein the holographic optical element comprises a plurality of holographic lenses disposed sequentially in the second direction, the holographic lenses are reflective holographic lenses or transmissive holographic lenses, the plurality of holographic lenses are disposed in correspondence with the plurality of second beam-splitting films, each of the holographic lenses has the interference fringes formed thereon for receiving light beams reflected from a corresponding second beam-splitting film and outputting the image light beams.

5. The near-eye display device according to claim 4, wherein the holographic lenses are recorded by a holographic lens recording system, when the holographic lenses are reflective holographic lenses, the holographic lens recording system comprises a first lens, a second lens, a glass substrate, a holographic film, and a third lens arranged in sequence; and
the holographic film is attached to the glass substrate; a signal light is collimated by the first lens and is focused on the holographic film through the second lens and the glass substrate; a reference light passes through the third lens to obtain a parallel reference light, the parallel light is incident on the holographic film and coherent with the signal light to form the interference fringes.

6. The near-eye display device according to claim 3, wherein the turning module is located at one end in a lengthwise direction of the out-coupler module, or above the out-coupler module; and
when the turning module is located at the one end in the lengthwise direction of the out-coupler module, the in-coupler module is located on a side of the turning module away from the out-coupler module.

7. The near-eye display device according to claim 6, wherein when the turning module is located at the one end in the lengthwise direction of the out-coupler module, a tapered portion is provided on a side of the first waveguide substrate away from the out-coupler module, the tapered portion has an oblique surface as a light incident surface, the in-coupler module is a triangular prism, and a light emitting surface of the triangular prism is attached to the light incident surface of the tapered portion, so that the triangular prism and the tapered portion form a triangular structure.

8. The near-eye display device according to claim 7, wherein a degree of an apex angle of the triangular structure away from the out-coupler module is twice a tilt angle of the second beam-splitting films, and a tilt angle of the first beam-splitting films is 45°.

9. The near-eye display device according to claim 1, wherein the laser generation module comprises a laser generation body and a collimation module, and the laser generation body comprises a light source, a beam combiner, and a scanning module arranged in sequence along a light propagation path, the light source is an RGB three-color light source, and a light beam emitted by the light source is integrated by the beam combiner and then passes through the scanning module and the collimation module in sequence to form the parallel laser beams.

10. The near-eye display device according to claim 9, wherein the optical waveguide element comprises an in-coupler module, a turning module, and an out-coupler module sequentially arranged along a light transmission direction, the in-coupler module is configured to couple the parallel laser beams into the turning module, the turning module is configured to change a propagation direction of the parallel laser beams and to achieve pupil expansion of the parallel laser beams in a first direction; the out-coupler module is configured to achieve pupil expansion of the parallel laser beams in a second direction after the pupil expansion in the first direction and to output the laser beams, the second direction is set at an angle to the first direction.

11. The near-eye display device according to claim 10, wherein the turning module comprises a first waveguide substrate and a first beam-splitting structure formed within the first waveguide substrate, the first beam-splitting structure comprises a plurality of first beam-splitting films spaced along the first direction; the out-coupler module comprises a second waveguide substrate and a second beam-splitting structure formed within the second waveguide substrate, the second beam-splitting structure comprises a plurality of second beam-splitting films spaced along the second direction.

12. The near-eye display device according to claim 11, wherein the holographic optical element comprises a plurality of holographic lenses disposed sequentially in the second direction, the holographic lenses are reflective holographic lenses or transmissive holographic lenses, the plurality of holographic lenses are disposed in correspondence with the plurality of second beam-splitting films, each of the holographic lenses has the interference fringes formed thereon for receiving light beams reflected from a corresponding second beam-splitting film and outputting the image light beams.

13. The near-eye display device according to claim 12, wherein the holographic lenses are recorded by a holographic lens recording system, when the holographic lenses are reflective holographic lenses, the holographic lens recording system comprises a first lens, a second lens, a glass substrate, a holographic film, and a third lens arranged in sequence; and
the holographic film is attached to the glass substrate; a signal light is collimated by the first lens and is focused on the holographic film through the second lens and the glass substrate; a reference light passes through the third lens to obtain a parallel reference light, the parallel light is incident on the holographic film and coherent with the signal light to form the interference fringes.

14. The near-eye display device according to claim 11, wherein the turning module is located at one end in a lengthwise direction of the out-coupler module, or above the out-coupler module; and
when the turning module is located at the one end in the lengthwise direction of the out-coupler module, the in-coupler module is located on a side of the turning module away from the out-coupler module.

15. The near-eye display device according to claim 14, wherein when the turning module is located at the one end in the lengthwise direction of the out-coupler module, a tapered portion is provided on a side of the first waveguide substrate away from the out-coupler module, the tapered portion has an oblique surface as a light incident surface, the in-coupler module is a triangular prism, and a light emitting surface of the triangular prism is attached to the light incident surface of the tapered portion, so that the triangular prism and the tapered portion form a triangular structure.

16. The near-eye display device according to claim 15, wherein a degree of an apex angle of the triangular structure away from the out-coupler module is twice a tilt angle of the second beam-splitting films, and a tilt angle of the first beam-splitting films is 45°.

17. A wearable device, comprising a near-eye display device, wherein the near-eye display device comprises:
a laser generation module;
an optical waveguide element; and
a holographic optical element;
wherein the laser generation module is configured to emit parallel laser beams;
the optical waveguide element has an in-coupler area and an out-coupler area, the optical waveguide element is configured to receive the parallel laser beams and output the parallel laser beams in parallel after one-dimensional pupil expansion or two-dimensional pupil expansion; and
the holographic optical element has interference fringes and is attached to the out-coupler area, the holographic optical element is configured to receive the parallel laser beams from the optical waveguide element and to reflect or transmit the parallel laser beams by diffraction to output a plurality of converging image light beams.

18. The wearable device according to claim 17, wherein the optical waveguide element comprises an in-coupler module, a turning module, and an out-coupler module sequentially arranged along a light transmission direction, the in-coupler module is configured to couple the parallel laser beams into the turning module, the turning module is configured to change a propagation direction of the parallel laser beams and to achieve pupil expansion of the parallel laser beams in a first direction; the out-coupler module is configured to achieve pupil expansion of the parallel laser beams in a second direction after the pupil expansion in the first direction and to output the laser beams, the second direction is set at an angle to the first direction.

19. The wearable device according to claim 18, wherein the turning module comprises a first waveguide substrate and a first beam-splitting structure formed within the first waveguide substrate, the first beam-splitting structure comprises a plurality of first beam-splitting films spaced along the first direction; the out-coupler module comprises a second waveguide substrate and a second beam-splitting structure formed within the second waveguide substrate, the second beam-splitting structure comprises a plurality of second beam-splitting films spaced along the second direction.

20. The wearable device according to claim 19, wherein the holographic optical element comprises a plurality of holographic lenses disposed sequentially in the second direction, the holographic lenses are reflective holographic lenses or transmissive holographic lenses, the plurality of holographic lenses are disposed in correspondence with the plurality of second beam-splitting films, each of the holographic lenses has the interference fringes formed thereon for receiving light beams reflected from a corresponding second beam-splitting film and outputting the image light beams.
